(19) United States
(12) Patent Application Publication
(10) Pub. No.: US 2017/0098835 A1
(43) Pub. Date: Apr. 6, 2017

(54) DETERMINING A SPATIAL DISTRIBUTION OF A THERMAL CONDUCTIVITY OF AN ELECTROCHEMICAL CELL

(71) Applicant: Commissariat A L'Energie Atomique et aux Energies Alternatives, Paris (FR)

(72) Inventors: Jean-Philippe POIROT-CROUVEZIER, Saint Georges De Commiers (FR); Fredy-lntelligent NANDJOU DONGMEZA, Grenoble (FR); Mathias GERARD, Grenoble (FR); Christophe ROBIN, Grenoble (FR)

(73) Assignee: Commissariat A L'Energie Atomique et aux Energies Alternatives, Paris (FR)

(21) Appl. No.: 15/271,382

(22) Filed: Sep. 21, 2016

(30) Foreign Application Priority Data
Sep. 21, 2015 (FR) 15 58897

(51) Int. Cl. H01M 8/0267; C25B 15/00; H01M 8/04007; C25B 9/08; H01M 8/0254; H01M 8/1004

(52) U.S. Cl. CPC H01M 8/0267; H01M 8/0254; H01M 8/1004; H01M 8/04067; C25B 9/08; C25B 15/00; H01M 2008/1095

(57) ABSTRACT

The invention relates to a method for determining a spatial distribution (Rh_{x,y}^{f}) of a parameter of interest (Rh) representative of heat removal within a bipolar plate of an electrochemical cell, wherein a spatial distribution (Rh_{x,y}^{f}) of the parameter of interest (Rh) is determined depending on the spatial distribution (D_{x,y}^{e}) of a second thermal quantity (D^{e}) estimated beforehand from the spatial distribution (T_{x,y}^{c}) of a set-point temperature (Tc) and from the spatial distribution (Q_{x,y}^{r}) of a first thermal quantity (Q^{r}).

### TECHNICAL FIELD

The technical field of the invention is that of electrochemical reactors including a stack of electrochemical cells, such as fuel cells and electrolyzers, and more precisely that of methods for determining a parameter representative of the local heat removal within an electrochemical cell, for example allowing the uniformity of the spatial distribution of the temperature of the cell in operation to be increased, and that of methods for producing an electrochemical-cell bipolar plate.

### STATE OF THE PRIOR ART

An electrochemical reactor such as a fuel cell or electrolyzer conventionally includes a stack of electrochemical cells that each comprise an anode and a cathode that are electrically separated from each other by an electrolyte, an electrochemical reaction taking place in each cell between two reactants that are continuously fed thereto. In the case of a hydrogen fuel cell, the fuel (hydrogen) is brought into contact with the anode, and the oxidant (oxygen), which is for example contained in air, is brought into contact with the cathode. The electrochemical reaction is subdivided into two half reactions, an oxidation reaction and a reduction reaction, which take place at the anode/electrolyte interface and at the cathode/electrolyte interface, respectively. To take place, the electrochemical reaction requires the presence of an ionic conductor between the two electrodes, namely the electrolyte, which optionally takes the form of a polymer membrane, and an electronic conductor formed by the external electric circuit. The stack of cells is thus the site of the electrochemical reaction, this requiring the reactive species to be supplied and the products and unreactive species and the heat produced to be removed.

The cells are conventionally separated from one another by bipolar plates that ensure the electrical interconnection of the cells. The plates include a circuit for distributing fuel, formed on an anodic side, and a circuit for distributing oxidant, formed on a cathodic side opposite the anodic side. Each distributing circuit is a network of channels that are parallel to one another and suitable for bringing the reactive species to the corresponding electrode. The bipolar plates may also include a cooling circuit formed from a network of internal ducts that allow a heat-transfer fluid to flow and thus the heat produced locally during the reaction in the cell to be removed.

Document FR2976732 describes an electrochemical cell produced so as to obtain uniform local heating within the cell in operation. The heating depends on the electrical current density at each point of the cell, which is itself dependent on the partial pressure of the reactive species. Specifically, considering here the cathodic side of the cell, the amount of oxygen contained in the gas flowing through the distributing circuit gradually decreases as the oxygen is consumed by the cell, thereby leading to a spatial variation in the electrical current density produced by the cell, and therefore to a spatial variation in the heating of the cell. To prevent this spatial nonuniformity in the heating of the cell, the electrical conductivity between the bipolar plate delivering the oxygen and the cell is adjusted locally so as to compensate for the decrease in the oxygen partial pressure.

However, the uniformity of the spatial distribution of the effective temperature of the electrochemical cell could still be improved, so as to preserve the lifetime of the cell by limiting the rate of the degradation reactions of the various components of the cell and by decreasing mechanical stresses of thermal origin that are liable to decrease the mechanical strength of the components of the cell.

### DISCLOSURE OF THE INVENTION

The objective of the invention is to remedy at least some of the drawbacks of the prior art, and more particularly to provide a method for determining the spatial distribution of a parameter representative of local heat removal from an electrochemical cell especially allowing the uniformity of the local temperature of the electrochemical cell in operation to be increased and thus the lifetime of the latter to be preserved.

To this end, the invention provides a method for determining a spatial distribution of a parameter of interest representative of heat removal within a bipolar plate of an electrochemical cell, said cell including two electrodes separated from one another by an electrolyte and placed between bipolar plates suitable for bringing reactive species to the electrodes and for removing the heat produced by the cell in operation, comprising the following steps:

i) providing an electrochemical cell, within which the parameter of interest is distributed with an initial spatial distribution and for which the spatial distribution of a temperature within the electrochemical cell in operation has at least one local value higher than or equal to a preset maximum local value;
ii) defining a spatial distribution of a set-point temperature within the cell in operation, said distribution being such that the local temperature values are lower than preset maximum local values;
iii) measuring a spatial distribution of a first thermal quantity representative of a local production of thermal energy within said electrochemical cell in operation;
iv) estimating a spatial distribution of a second thermal quantity representative of a local flow rate of a heat-transfer fluid in a cooling circuit of a bipolar plate of the electrochemical cell in operation, depending on said spatial distribution of the set-point temperature and on said spatial distribution of the first thermal quantity, so that the spatial distribution of the temperature of said electrochemical cell in operation—the first thermal quantity of which cell has said measured spatial distribution and the second thermal quantity of which cell has said estimated spatial distribution—is substantially equal to that of the set-point temperature; and
v) determining a spatial distribution of the parameter of interest depending on the estimated spatial distribution of the second thermal quantity.

Thus, a spatial distribution of the parameter of interest is obtained and taking into account this spatial distribution in the considered electrochemical cell makes it possible to ensure that the latter has, in operation, a spatial distribution of temperature corresponding substantially to that of the set-point temperature. Thus, in operation the electrochemical cell then does not present zones in which the temperature is locally above preset maximum local values.

The supply of the electrochemical cell may include a phase of experimentally prototyping or numerically modelling an electrochemical cell, a phase of measuring the spatial distribution of the temperature within the electrochemical cell in operation, then a phase of comparing the measured spatial distribution of the temperature to a preset spatial distribution of a maximum temperature. The local values of this spatial distribution of maximum temperature are the what are called preset maximum local values. When at least one local value of the measured temperature is higher than or equal to a corresponding preset maximum local value, i.e. at the same position within the spatial distribution, the electrochemical cell is then supplied, i.e. considered, for the following steps of the determining method.

The set-point temperature may be defined so that the local temperature values are below the corresponding maximum local values. The set-point temperature may comprise substantially constant local values, or even a substantially constant local temperature gradient. It may have local values that are not constant within the spatial distribution but that remain below these preset maximum values. It may also comprise a local gradient that is not constant within the spatial distribution but that remains below the preset maximum values.

The measurement of the spatial distribution of the first thermal quantity may be an experimental measurement carried out on the considered electrochemical cell, which will have been manufactured beforehand, or a numerical measurement carried out on a numerical model of the considered electrochemical cell. The first thermal quantity may be a local production of thermal energy within the cell in operation.

The estimation of the spatial distribution of the second thermal quantity may include:

a phase of generating a mesh, for example a two-dimensional or three-dimensional mesh, of a cooling circuit of at least one bipolar plate of the electrochemical cell, through which circuit a heat-transfer fluid is intended to flow; and

a phase of simulating numerically by computer the second thermal quantity on said mesh, by solving a discrete numerical model relating the second thermal quantity to the local temperature and to the first thermal quantity.

In this case, the numerical model takes into account the spatial distribution of the set-point temperature and the spatial distribution measured beforehand of the first thermal quantity. This discrete numerical model, which is what is called an electrochemical model, may be a relationship relating a parameter representative of the local heat removal, for example the local flow rate of the heat-transfer fluid, to the local temperature and to a parameter representative of the local production of heat, for example the local heat flux.

Thus, the electrochemical cell, the spatial distribution of the parameter of interest of which was obtained by the determining method, has in operation a spatial distribution of temperature substantially equal to that of the set-point temperature. Thus, the generation of unwanted new hotspots or new temperature nonuniformities that could appear if the spatial distribution of the parameter of interest were determined using an essentially thermal approach, i.e. an approach based on a comparison of the actual temperature of hotspots or nonuniformities and the set-point temperature, is avoided.

Preferably, the parameter of interest is a hydraulic resistance or a geometric coefficient of minor head losses within a cooling circuit of at least one of the bipolar plates, through which circuit a heat-transfer fluid is intended to flow.

Preferably, the bipolar plates are formed from two sheets that are bonded to each other, each sheet including embossments forming, in what is called an external face, a circuit for distributing a reactive species, the embossments of the sheets together forming, in what are called internal faces that are opposite the external faces, a cooling circuit including cooling channels that communicate fluidically with one another between an inlet and an outlet of the cooling circuit. The external faces of the sheets are oriented toward an electrochemical-cell electrode. The cooling channels communicate fluidically with one another in the sense that, between the inlet and the outlet of the cooling circuit, they form a two-dimensional fluidic network, i.e. a non-linear network.

Preferably, the step of determining the spatial distribution of the parameter of interest is carried out also depending on a preset overall electrical power value of the electrochemical cell. It is then possible both to manage the local temperature within the electrochemical cell, with the aim of optimizing the lifetime thereof, and to maintain a wanted electrical power.

Preferably, the first thermal quantity is an effective local temperature measured within the cell in operation, and the second thermal quantity is a comparative quantity representative of a local difference between the effective temperature and the set-point temperature.

Preferably, step v) includes:

a sub-step of identifying at least one zone of the cell in which the second thermal quantity has an estimated local value above a preset threshold value;

a sub-step of determining the spatial distribution of the parameter of interest by modifying its initial value in at least one zone Zj that is spatially separate from the zone Zi identified beforehand, so as to increase the value of a parameter representative of the flow rate of a heat-transfer fluid in the zone Zi.

Preferably, the cooling circuit including a plurality of ducts through which the heat-transfer fluid is intended to flow, step v) includes:

a sub-step of identifying at least one zone Zi of the cell in which the second thermal quantity has an estimated local value above a preset threshold value, and of identifying said one or more ducts passing through the identified zone Zi;

a sub-step of determining the spatial distribution of the parameter of interest by modifying its initial value in at least one duct not passing through the zone Zi identified beforehand, so as to increase the value of a parameter representative of the flow rate of a heat-transfer fluid in said one or more ducts passing through said zone Zi.

Preferably, the first thermal quantity is representative of a production of thermal energy within the cell in operation, and the second thermal quantity is representative of a flow rate of a heat-transfer fluid through a cooling circuit of a bipolar plate of the cell.

Preferably, in step iv), the spatial distribution of the flow rate of the heat-transfer fluid allowing said produced heat to be removed is estimated depending on the spatial distribution so as to obtain said spatial distribution of the set-point temperature.

Preferably, in step v), the spatial distribution of the parameter of interest is determined so that the flow rate of the heat-transfer fluid through the cooling circuit has the spatial distribution estimated beforehand.

The invention also relates to a method for producing an electrochemical-cell bipolar plate, including steps of:

considering a reference electrochemical cell, said cell including two electrodes separated from each other by an electrolyte and placed between bipolar plates suitable for bringing reactive species to the electrodes and for removing the heat produced by the cell in operation via a cooling circuit through which a heat-transfer fluid is intended to flow, the cooling circuit having a parameter of interest representative of a hydraulic resistance or a geometric coefficient of minor head losses, said parameter being spatially distributed with an initial distribution;

determining a spatial distribution of the parameter of interest using the method according to any one of the preceding features; and

producing said bipolar plate in such a way that the parameter of interest has the determined spatial distribution.

Preferably, an insert is added to at least one duct of the cooling circuit, said insert having a thickness transverse to a longitudinal axis of said duct suitable for locally increasing the hydraulic resistance of the duct.

Preferably, an insert is added to at least one duct of the cooling circuit, said insert being formed from at least one plate section of substantially constant thickness, including at least one embossment suitable for locally creating a minor head loss.

The invention also relates to a method for producing an electrochemical cell including two electrodes separated from each other by an electrolyte and placed between two bipolar plates suitable for bringing reactive species to the electrodes and for removing the heat produced by the cell in operation, the method including the following steps of:

considering a reference electrochemical cell having a parameter of interest representative of a heat removal within a bipolar plate of an electrochemical cell and distributed with an initial spatial distribution;

determining a spatial distribution of the parameter of interest using the determining method according to any one of the preceding features; and

producing the electrochemical cell on the basis of the reference electrochemical cell in which the parameter of interest has the determined spatial distribution.

By “on the basis of”, what is meant is that the produced electrochemical cell has the same electrochemical properties as those of the reference cell, with the exception of the parameter of interest, which is distributed with the determined spatial distribution. The produced electrochemical cell may be the reference cell in which the initial spatial distribution of the parameter of interest has been modified to be substantially equal to the determined spatial distribution.

The invention also relates to a storage medium containing instructions for implementing the determining method according to any one of the preceding features, these instructions being executable by a processor.

### BRIEF DESCRIPTION OF THE DRAWINGS

Other aspects, aims, advantages and characteristics of the invention will become more clearly apparent on reading the following detailed description of preferred embodiments thereof, which description is given by way of nonlimiting example and with reference to the appended drawings, in which:

FIG. 1a is a schematic cross-sectional representation of an exemplary electrochemical cell, and FIG. 1b is a schematic representation illustrating the correlational relationship between the spatial distribution of the heat production Q and the spatial distribution of heat removal P, which relationship results in the spatial distribution of effective temperature T of the electrochemical cell in operation;

FIG. 2 is a flowchart of a method for determining the spatial distribution of the hydraulic resistance of a cooling circuit of a bipolar plate of an electrochemical cell according to a first embodiment;

FIG. 3 is a flowchart of a method for determining the spatial distribution of the hydraulic resistance of a cooling circuit of an electrochemical cell according to a second embodiment;

FIG. 4 is an example of a mesh of the cooling circuit, in which each mesh cell includes a local heat production term Q_{i,j}^{r} a local heat removal term D_{i,j}^{e}, and a local set-point temperature Q_{i,j}^{c};

FIG. 5a illustrates partially and in transverse cross section a reference bipolar plate including a cooling circuit and FIG. 5b is a similar view to that in FIG. 5a but in which the bipolar plate includes inserts allowing local hydraulic resistance to be increased, and FIG. 5c is a longitudinal cross-sectional view of an insert according to one variant allowing minor head losses to be generated; and

FIG. 6 illustrates an example of the flow rate through ducts of a cooling circuit of a reference bipolar plate (dashed line) and through a bipolar plate equipped with inserts (solid line).

### DETAILED DESCRIPTION OF PARTICULAR EMBODIMENTS

In the figures and in the rest of the description, the same references are used to reference identical or similar components. In addition, the various components are not shown to scale so as to make the figures clearer. Moreover, the various embodiments and variants are not mutually exclusive and can be combined with one another. Unless indicated otherwise, the terms “substantially”, “about” and “of the order of” mean to within 10%.

The various embodiments and variants will be described with reference to a fuel cell and in particular to a PEM (proton exchange membrane) hydrogen fuel cell the cathode of which is supplied with oxygen and the anode of which is supplied with hydrogen. However, the invention is applicable to any type of fuel cell, and in particular to those operating at low temperatures, i.e. temperatures below 250° C., and to electrochemical electrolyzers.

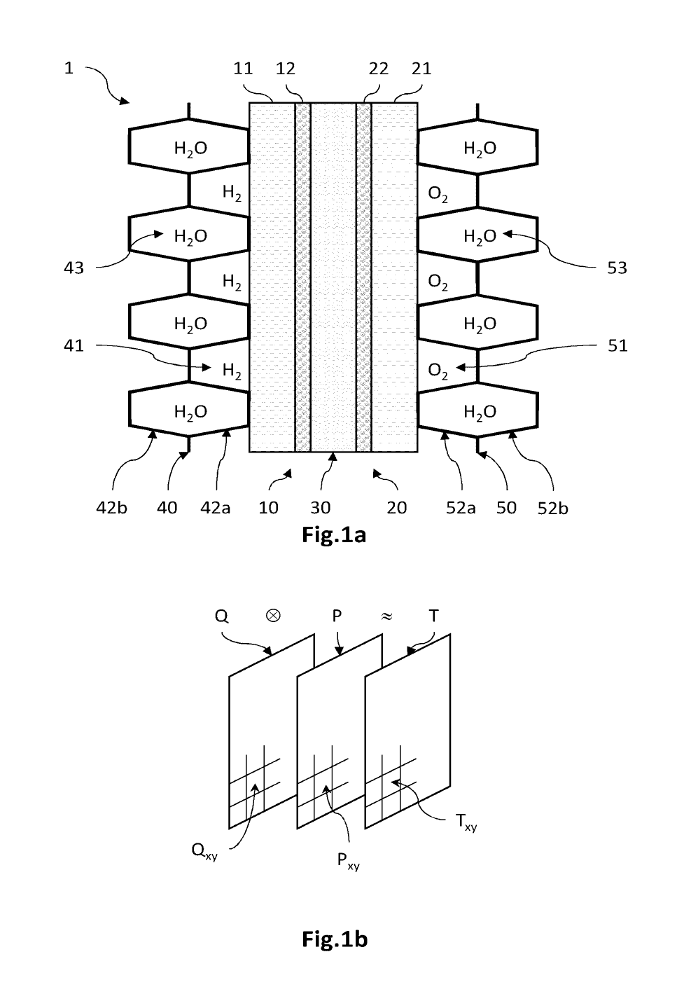

FIG. 1a partially and schematically illustrates an exemplary electrochemical cell 1 belonging to a stack of cells of a PEM fuel cell. The cell 1 includes an anode 10 and a cathode 20 that are separated from each other by an electrolyte here comprising a polymer membrane 30, the electrodes 10, 20 being placed between two bipolar plates 40, 50 that are suitable for bringing reactive species to the electrodes and for removing the heat produced by the electrochemical reaction.

Each electrode 10, 20 includes a gas diffusion layer (GDL) 11, 21 placed in contact with one of the bipolar plates 40, 50 and an active layer 12, 22 located between the membrane 30 and the diffusion layer 11, 21. The diffusion layers 11, 21 are made from a porous material that permits the diffusion of the reactive species from the distributing circuit of the bipolar plates to the active layers, and the diffusion of the products generated by the electrochemical reaction to the same distributing circuit. The active layers 12, 22 are the site of electrochemical reactions. They include materials suitable for allowing the oxidation and reduction reactions at the respective interfaces of the anode and cathode with the membrane to take place. More precisely, they each include an ionomer ensuring the protonic conductivity, for example Nafion, a catalyst for generating the electrochemical reaction, for example platinum, and an electrically conductive carrier, for example a carbon-containing matrix.

The bipolar plates include a circuit 41 for distributing hydrogen, which circuit is located on an anodic side, and a circuit 51 for distributing oxygen, which circuit is located on a cathodic side. They are here formed from two metal sheets 42a, 42b; 52a, 52b, that are joined to one another and pressed so as to form the distributing circuits. The arrangement of the embossments also allows a cooling circuit 43, 53 to be produced inside the plates, so as to allow a heat-transfer fluid to flow therethrough without making contact with the electrodes. Other bipolar-plate technologies may be used, for example the plates may be produced from a composite, for example a composite filled with graphite, and in which the embossments are produced by molding.

The cooling circuit is therefore formed from a network of ducts the size and orientation and possibly the interconnection of which depend both on those of the channels of the fuel-distributing circuit and on those of the channels of the oxidant-distributing circuit. The ducts are substantially parallel to one another and extend between an inlet and an outlet of the cooling circuit. They may be fluidically independent of one another or be connected to one another, and hence the fluid flowing through the cooling circuit may or may not remain confined in each of the ducts.

Each duct has local geometric properties that may induce a minor head loss or a modification of the hydraulic resistance, this possibly modifying the flow rate of the heat-transfer fluid in the duct. By way of example, these local geometric properties may be a variation in the flow cross section of the fluid, or even a change in the orientation of the duct (for example an elbow). It is thus possible to define:

a local geometric coefficient ζ_{xy} of minor head loss, such that ΔPs≈ζ_{xy}·v²/2g, where ΔPs is the minor head loss, v the incident speed of the fluid and g the gravitational constant. The value of the geometric coefficient ζ_{xy} depends on the nature of the local modification of the flow of the fluid.

a local hydraulic resistance Rh_{xy} of a duct, which corresponds to the ratio of the pressure difference between the inlet and outlet of the duct to the volume flow rate of the heat-transfer fluid. It is related to local hydraulic diameter by the relationship: Rh_{xy} ∝1/dh_{xy}⁴, the local hydraulic diameter dh_{xy} being defined as the ratio of the area of the flow cross section of the heat-transfer fluid to the perimeter of the flow cross section.

Thus, a local modification of the orientation of the duct and a variation in the hydraulic diameter may lead to a minor head loss and/or to a variation in hydraulic resistance, this resulting in a modification of the flow rate of the heat-transfer fluid in the cooling duct. The volume flow rate of the heat-transfer fluid is therefore not uniform within the cooling circuit, this resulting in nonuniformities in the spatial distribution of the calorific power locally removed by the heat-transfer fluid.

FIG. 1b schematically shows the spatial distribution of the temperature T_{xy of the electrochemical cell as resulting from a correlational relationship between:}

the spatial distribution of a quantity representative of the production of heat by the cell, for example the heat flux Q_{xy} produced locally; and

the spatial distribution of a quantity representative of the removal of the produced heat, for example the calorific power Pζ_{xy} received locally and removed by the heat-transfer fluid in the cooling circuit.

Thus, contrary to the teaching of patent application FR2976732 cited above, it is not enough to increase the uniformity of the distribution of production of heat Q_{xy} and therefore that of the heating of the cell to make the distribution of the temperature T_{xy} of the cell uniform. Specifically, it is important to take into account both the presence of possible local nonuniformities in the heat-production term Q_{xy} and the presence of possible local nonuniformities in the heat-removal term P_{xy}.

This is because the local production of heat, or more precisely the local produced heat flux Q_{x,y}, is directly proportional to the local electrical power production, and more precisely to the local current density I_{x,y}, as expressed by the relationship between their respective spatial distributions:

Q_{x,y}=I_{x,y}(ΔH/2F−U_{x,y}) (1)

where ΔH is the enthalpy of the electrochemical reaction, F is Faraday's constant, and U_{x,y} is the spatial distribution of the local voltage of the cell, the enthalpy and voltage possibly being considered to be almost uniform at every point of the cell. Thus, the production of heat is impacted by any nonuniformity due to fluidic parameters (dimensions of the circuits for distributing reactive species, etc.) electrochemical parameters (local properties of the electrodes and of the membrane, etc.) but also electrical parameters (electrical resistances of the various components of the cell, for example the resistivities of the materials and the contact resistances between the components of the cell, etc.), which parameters all influence the current-density distribution.

Moreover, as mentioned above, the calorific power P_{xy} received and removed locally by the heat-transfer fluid may also present local nonuniformities due to nonuniformities in the flow rate in the cooling circuit, as expressed by the relationship:

P_{x,y}=D_{x,y}·cₚ·δT_{x,y} (2)

where D_{x,y} is the local volume flow rate of the heat-transfer fluid in the cooling circuit, cₚ is the specific heat capacity of the heat-transfer fluid, and δT_{x,y} is a local variation in the temperature of the heat-transfer fluid within the cooling circuit.

In the context of the invention, it is sought to define the spatial distribution of a parameter of interest representative of the local removal of thermal energy so that the spatial distribution of the effective temperature of the cell in operation corresponds to that of a set-point temperature, while also taking into account the spatial distribution of a parameter representative of the effective production of thermal energy within the electrochemical cell.

By parameter of interest representative of local heat removal, what is meant is a parameter the value of which represents the capacity of the cell, and more precisely of the cooling circuit of at least one bipolar plates of the cell, to locally remove the produced heat. It may thus be a question of the calorific power P_{x,y} received locally by the heat-transfer fluid in the cooling circuit, of the local flow rate D_{x,y} of the heat-transfer fluid, and, preferably, of the local hydraulic resistance Rh_{x,y} of the cooling circuit or of an equivalent parameter (such as the local hydraulic diameter), or even of the local geometric coefficient ζ_{xy} of minor head loss.

By parameter representative of the production of thermal energy, what is meant is a parameter the value of which influences locally the produced heat flux Q_{x,y}. It is here in particular a question of any parameter that influences the local current density I_{x,y}. It may be a question of the electrical resistance Re_{x,y} of the cell, which especially depends on the resistivity of the various components of the cell (bipolar plates, diffusion layers, active layers, membrane) and on the electrical contact resistance between each of these components. It may also be a question of the load C_{x,y} (or loading or weight per unit area) of catalyst in the active layer insofar as it directly influences the local current density I_{x,y}, or even of the permeability k_{x,y} of the diffusion layer of the electrodes, which determines the amount of reactive species capable of diffusing locally as far as the active layer.

By temperature of the cell, what is meant is local temperature, i.e. the spatial distribution of the temperature of any one of the components of the cell, for example one of the bipolar plates or even one of the electrodes. The temperature of the cell may thus correspond to the spatial distribution of temperature in the cooling circuit. The effective temperature of the cell is the spatial distribution of the temperature of the cell in operation, at the polarization point defined by the voltage of the cell Uₜₒₜ and the total current density Iₜₒₜ, i.e. the local current density I_{x,y} integrated over the entire area of the cell.

Lastly, by spatial distribution of a parameter, what is meant is the local value of this parameter at every point in the cell, or more precisely, at every point (x,y) in a plane parallel to the cell in the what is called active zone corresponding to the areal extent of the active layers of the electrodes.

Thus, the electrochemical cell the parameter of interest representative of the local heat removal of which is spatially distributed with the distribution thus determined has an effective temperature, or temperature during operation of the cell, substantially equal to the set-point temperature. This set-point temperature advantageously has a spatial distribution that is substantially uniform scalarwise or gradientwise. By uniform scalarwise, what is meant is that the local value of the temperature is substantially constant. By uniform gradientwise, what is meant is that the local temperature gradient is substantially constant. The local temperature values may however not be constant while remaining below preset maximum local values. Thus, the cell advantageously does not contain zones of excess temperature, also called hotspots, that on the one hand may increase the rate of the degradation reactions of the components of the cell, and on the other hand may generate mechanical stresses liable to degrade the mechanical strength of the components of the cell. The lifetime of the electrochemical cell is then preserved. By hotspot, what is for example meant is a zone of the cell that contains a temperature peak or a temperature-gradient peak. More precisely, a hotspot may be a zone where the difference between the local temperature and the inlet temperature of the cooling circuit is larger than the product of a coefficient and the temperature difference between the inlet and outlet of the cooling circuit, the coefficient possibly being about 1.1 to 3 or more, and preferably being about 1.5. By way of example, for a temperature of 77° C. at the inlet of the cooling circuit and of 80° C. at the outlet of the circuit, and for a coefficient equal to 1.5, a hotspot is a zone of the cell in which the local temperature exceeds 81.5° C.

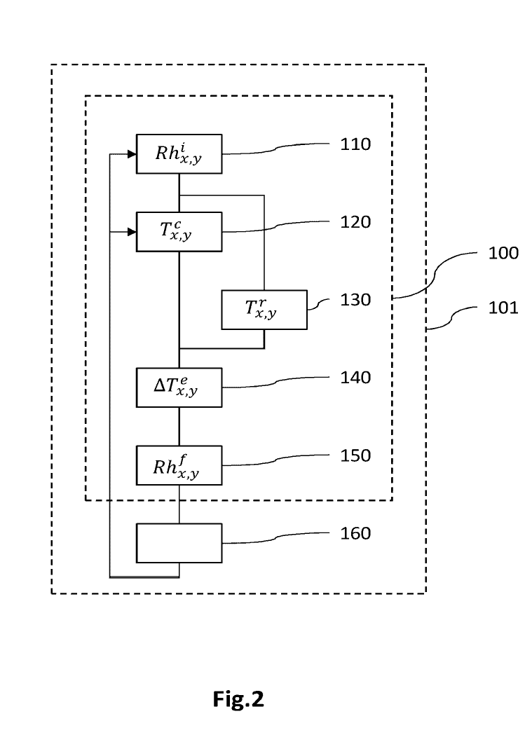

FIG. 2 is a flowchart of a method for determining the spatial distribution of the parameter of interest representative of the local heat removal, according to a first embodiment. In this example, the parameter of interest is the local hydraulic resistance Rh_{xy} of the cooling circuit of at least one of the bipolar plates of the electrochemical cell, the value of which has a direct influence on the local flow rate of the heat-transfer fluid in the cooling ducts and therefore on the local calorific power received then removed by the heat-transfer fluid. Alternatively and optionally complementarily, the parameter of interest may be the local geometric coefficient ζ_{xy} of minor head loss.

The value of the local hydraulic resistance Rh_{xy} modifies the local flow rate Dζ_{xy} in the case where the ducts are interconnected, or the average flow rate D̅ₖ through the duct k in question in the case where the ducts are not interconnected. In both situations, a local modification of the flow rate in a determined zone of the cooling circuit induces, by the principle of conservation of mass (expressed by the continuity equation in fluid mechanics), a variation in the flow rate in the other zones of the circuit.

According to this first embodiment 100, an optimized spatial distribution Rh_{x,y}^{f} of the hydraulic resistance Rh is determined from the estimation of the spatial distribution ΔT_{x,y}^{e} of a comparative thermal quantity ΔT^{e} representing the difference between an effective temperature T^{r} of the cell in operation—in which cell the hydraulic resistance is distributed with a given initial distribution Rh_{x,y}ⁱ—and a preset set-point temperature T^{c}. It is then possible to produce a bipolar plate the hydraulic resistance of the cooling circuit of which has the optimized distribution Rh_{x,y}^{f}, so that the effective temperature T^{r} of the cell thus modified is substantially equal to the set-point temperature T^{c}.

In a first step 110, a reference electrochemical cell is defined one of the bipolar plates of which includes a cooling circuit within which the hydraulic resistance Rh is spatially distributed with an initial distribution Rh_{x,y}ⁱ. The cell has a structure identical or similar to that described with reference to FIG. 1. The initial distribution Rh_{x,y}ⁱ of the hydraulic resistance may contain local nonuniformities and thus induce variations in the flow rate of the heat-transfer fluid.

In a step 120, a spatial distribution T_{x,y}^{c} of a set-point temperature T^{c} of the reference cell when the latter is in operation and producing a total current density Iₜₒₜ for a given voltage Uₜₒₜ is defined. To the first order, the set-point temperature T^{c} of the cell may correspond to a temperature of the heat-transfer fluid in the cooling circuit, the distribution of this temperature then especially depending on its values at the inlet Tₑ^{c} and outlet Tₛ^{c} of the heat-transfer fluid in the cooling circuit. By way of illustration, the inlet temperature may be set beforehand, for example to 75° C., and the outlet temperature may be estimated from the thermal power Pₜₕ to be removed, the latter corresponding to the electrical power Pₑ=Iₜₒₜ. Uₜₒₜ delivered by the cell in operation. The thermal power Pₜₕ is estimated from the local produced heat flux Q_{x,y} integrated over the entire area of the active zone, said flux being obtained from relationship (1). The outlet temperature Tₛ^{c} may then be estimated from relationship (2) extended to all the active zone:

Pₜₕ=∫∫Q_{x,y}dxdy=D̅ₜₒₜ·cₚ·(Tₛ^{c}−Tₑ^{c}) (3)

where D̅ₜₒₜ is the total average flow rate of the heat-transfer fluid flowing through the cooling circuit. It is then possible to define the spatial distribution T_{x,y}^{c} of the set-point temperature T^{c} from the values of the temperature of the heat-transfer fluid at the inlet Tₑ^{c} and outlet Tₛ^{c} of the cooling circuit, the distribution T_{x,y}^{c} advantageously being uniform gradientwise, i.e. the local set-point temperature gradient is substantially constant.

In a step 130, a spatial distribution T_{x,y}^{r} of a first thermal quantity representative of the temperature of the cell in operation is obtained. The first thermal quantity is here the effective temperature 7 of the electrochemical cell when it is operating under the same operating conditions as those considered in step 120. This distribution T_{x,y}^{r} is not estimated but is the result of a measurement by experimental or numerical means. It may thus be obtained by experimental measurement within an electrochemical cell having the same properties as the reference cell defined in step 110, for example by means of a S++ board sold by “S++ Simulation Services”, including an invasive plate inserted between two bipolar plates and suitable for measuring a spatial distribution of temperature. The distribution T_{x,y}^{r} of effective temperature may also be obtained by numerical simulation from an electrochemical cell model, for example that described in the publication by Inoue et al., Numerical analysis of relative humidity distribution in polymer electrolyte fuel cell stack including cooling water, J. Power Sources 162 (2006) 81-93.

The distribution T_{x,y}^{r} of the effective temperature T^{r} obtained by experimental or numerical measurement thus takes into account local nonuniformities in the effective produced heat flux, which depends on local current density, and local nonuniformities in the effective heat removal, which especially depends on the local flow rate of the heat-transfer fluid in the cooling circuit.

In a step 140, the spatial distribution of a second thermal quantity is estimated, here a comparative quantity ΔT^{e} representative of a local difference between the effective temperature T^{r} and the set-point temperature T^{c}. This comparative local quantity ΔT^{e} is estimated from the spatial distribution T_{x,y}^{c} of the set-point temperature T^{c} defined in step 120 and from the spatial distribution T_{x,y}^{r} of the effective temperature T^{r} measured in step 130. It may be a question of the difference between the local value of the effective temperature and that of the set-point temperature, or of a ratio of these values, inter alia. Here, the term-to-term difference between the distributions of the effective temperature and the set-point temperature are considered: ΔT_{x,y}^{e}=T_{x,y}^{r}−T_{x,y}^{c}.

In a step 150, a spatial distribution Rh_{x,y}^{f} of the hydraulic resistance Rh is determined depending on the spatial distribution ΔT_{x,y}^{e} of the comparative quantity ΔT^{e}.

Firstly at least one zone Zᵢ of the cell in which the comparative quantity ΔT^{e} has a value higher than or equal to a preset threshold value is first identified, the threshold value for example being representative of a hotspot.

Secondly, according to a first variant in which the cooling ducts are interconnected, the spatial distribution of Rh_{x,y}^{f} the hydraulic resistance Rh is determined by identifying at least one zone Zⱼ that is spatially separate from the zone Zᵢ, a local hydraulic resistance value above the initial local value being attributed to said zone so that the flow rate in the hotspot zone Zᵢ has a new local value above its initial value, by virtue of the principle of conservation of mass.

According to another variant in which the cooling ducts are not interconnected, the spatial distribution Rh_{x,y}^{f} of the hydraulic resistance Rh is determined by identifying at least one duct kⱼ that does not pass through the identified zone Zᵢ, a hydraulic resistance value above its initial value being attributed thereto so that the flow rate in the one or more ducts kᵢ passing through the hotspot zone Zᵢ has a new local value above its initial value, by virtue of the principle of conservation of mass.

These two variants differ from each other insofar as, in the case where the ducts are interconnected, the flow rate through the cooling circuit is equivalent to the flow rate through a porous medium in which the pores are interconnected. It is therefore necessary to determine the spatial location of the modification of the hydraulic resistance. Conversely, in the case where the ducts are not interconnected, the flow rate in each duct depends essentially on the hydraulic resistance thereof, and not on the spatial location of the modification of the hydraulic resistance.

Thus, the calorific power P_{Zi} removed in the zone Zᵢ is increased, thereby contributing to decreasing the difference, in this zone, between the effective temperature and the set-point temperature, and therefore to attenuating or even suppressing the hotspot. The spatial distribution Rh_{x,y}^{f} of the hydraulic resistance Rh is determined via a parametric study, for example by means of a particle image velocimetry (PIV) technique, or by iterative inverse simulation, for example by means of a flow simulation software package such as FLUENT or COMSOL. Concretely, the local value of the hydraulic resistance within the cooling circuit is modified and the corresponding local flow rate measured. This operation is reiterated until the difference ΔT_{x,y}^{e} is minimized. This difference may be minimized using conventional optimization algorithms, such as, for example, a gradient descent minimization algorithm.

Advantageously, the distribution is determined without modifying the flow properties in the circuits for distributing reactive species. To do this, the hydraulic diameter of the cooling ducts is not increased, but the hydraulic resistance (or the local geometric coefficient) within the cooling circuit is increased, in the parametric study or the study by numerical simulation.

Thus a spatial distribution Rh_{x,y}^{f} of the hydraulic resistance Rh of the cooling circuit of the bipolar plate of the electrochemical cell is obtained. It is then possible to modify the initial distribution Rh_{x,y}^{f} of the hydraulic resistance Rh of the cooling circuit of the bipolar plate of the reference cell so that it has the new distribution determined in step 150, or to produce a bipolar plate the cooling circuit of which has the spatial distribution Rh_{x,y}^{f} of the hydraulic resistance Rh. The cell including such a bipolar plate thus optimized then has, in operation, an effective temperature T^{r} the spatial distribution of which is substantially equal to that of the set-point temperature T^{c}. Insofar as the distribution of the set-point temperature is advantageously spatially uniform, the cell in operation has an effective temperature the distribution of which is also substantially uniform, thus allowing the lifetime of the cell to be preserved.

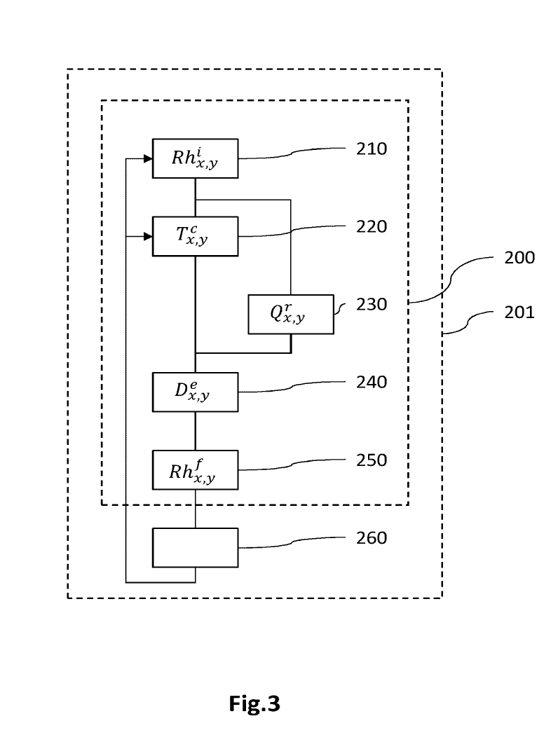

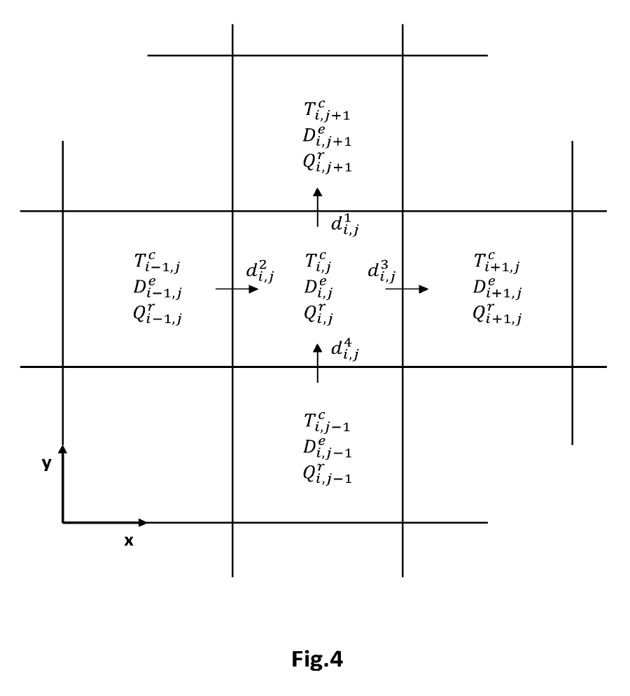

FIG. 3 is a flowchart of a method for determining the spatial distribution of a parameter of interest representative of the local heat removal, according to a second embodiment. In this example, the parameter of interest is the hydraulic resistance of the cooling circuit of at least one of the bipolar plates of the electrochemical cell, the value Rh_{x,y} of which has a direct influence on the local flow rate of the heat-transfer fluid and therefore on the calorific power received then removed by the heat-transfer fluid. Alternatively and optionally complementarily, the parameter of interest may be the local geometric coefficient ζ_{xy} of minor head loss.

According to this second embodiment 200, a spatial distribution Rh_{x,y}^{f} of the hydraulic resistance Rh is determined from the estimation of the spatial distribution of a thermal quantity representative of the heat removal in the cell so as to allow the spatial distribution of a set-point temperature to be obtained, while taking into account the spatial distribution of a thermal quantity representative of the effective production of heat produced by the cell. It is then possible to produce a bipolar plate the hydraulic resistance of the cooling circuit of which has the optimized distribution Rh_{x,y}^{f} so that the effective temperature T^{r} of the cell thus modified is substantially equal to the set-point temperature T^{c}. The electrochemical cell, the parameter of interest of which is spatially distributed with the optimized distribution, has in operation a temperature substantially equal to the set-point temperature. Unwanted new hotspots or new temperature nonuniformities are not formed.

This approach, which is what may be referred to as an electrochemical and no longer essentially thermal approach, is particularly advantageous when at least one bipolar plate, or even both bipolar plates, of the electrochemical cell are formed from sheets that are bonded to one another and that contain embossments that define a two-dimensional cooling circuit. The embossments of each sheet, in the faces referred to as the external faces of the sheets, i.e. the faces oriented toward an electrode, define a circuit for distributing reactive species. In the internal faces, i.e. the faces opposite the external faces, the embossments form a cooling circuit through which a heat-transfer fluid is intended to flow. The cooling circuit is what is called linear when the cooling channels do not communicate with one another, i.e. when the heat-transfer fluid, between the inlet and outlet of the cooling circuit, cannot substantially pass from one cooling channel to another. The cooling circuit is what is called two-dimensional when the cooling channels communicate with one another, so as to form a fluidic network that is two-dimensional and non-linear. This is especially the case when the distributing channels of a sheet are not parallel to those of the other sheet.

In a first step 210, a reference electrochemical cell is defined or supplied, at least one of the bipolar plates of which includes a cooling circuit within which the hydraulic resistance Rh is spatially distributed with an initial distribution Rh_{x,y}ⁱ. The cell has a structure identical or similar to that described with reference to FIG. 1. The initial distribution Rh_{x,y}ⁱ of the hydraulic resistance may contain local nonuniformities and thus induce variations in the flow rate of the heat-transfer fluid. This step is similar or identical to the step 110 described above. The considered electrochemical cell then has, in operation, a spatial distribution of temperature at least one local value of which is higher than or equal to a preset maximum local value. The latter may be constant or differ depending on the considered point of the electrochemical cell. This step may include:

a phase of experimentally prototyping or numerically modelling an electrochemical cell;

a phase of measuring the spatial distribution of the temperature within the electrochemical cell in operation; then

a phase of comparing the measured spatial distribution of the temperature to a preset spatial distribution of a maximum temperature. The local values of this spatial distribution of maximum temperature are the what are called preset maximum local values.

When at least one local value of the measured temperature is higher than or equal to a corresponding preset maximum local value, i.e. at the same position within the spatial distribution, the electrochemical cell is then supplied, i.e. considered, for the following steps of the determining method.

In a step 220, a spatial distribution T_{x,y}^{c} of a set-point temperature T^{c} of the reference cell when the latter is in operation and producing a total current density Iₜₒₜ for a given voltage Uₜₒₜ is defined. This step is similar or identical to the step 120 described above. The local values of the spatial distribution of the set-point temperature are lower than corresponding maximum local values.

Optionally, it is advantageous to specify the spatial distribution T_{x,y}^{c} of the set-point temperature T^{c} as a function of the spatial distribution of the concentration of reactive species in the active zone between the inlet and outlet of the corresponding distributing circuit. Specifically, the consumption of reactive species within the active zone of the cell leads to a gradual decrease in the concentration of reactive species along the distributing circuit. This gradual decrease results in a decrease in the local current density produced by the cell and therefore in the local production of heat, thereby possibly leading to the formation of nonuniformities in the temperature of the cell. To compensate for this gradual decrease in the production of heat, it is advantageous to define a set-point temperature that takes into account the decrease in the concentration of reactive species, so that the effective temperature of the cell in operation corresponds to the set-point temperature, the latter advantageously having a uniform spatial distribution. To do this, the spatial distribution \tilde{T}_{x,y}^{c} of the specified set-point temperature \tilde{T}^{c} may for example be written:

\tilde{T}_{x,y}^{c}=T_{x,y}^{c}+Kⁱ·[max(c_{x,y}ⁱ)−c_{x,y}ⁱ] (4)

where c_{x,y}ⁱ is the spatial distribution of the concentration cⁱ in reactive species i, for example in oxygen, and Kⁱ is a positive constant, for example close to 1, which may be subsequently adjusted. The spatial distribution c_{x,y}ⁱ of the concentration cⁱ may be estimated to the first order from the routing of the channels of the distributing circuit of the reactive species in question and by assuming a uniform consumption of the reactive species i throughout the active zone. It may also be more accurately determined by numerical or experimental measurement of the spatial distribution of the current density in a cell that is similar or identical to the reference cell, which allows the spatial distribution of the concentration of the reactive species to be deduced. Other relationships (4) may be used to specify the spatial distribution of the set-point temperature while taking into account the spatial variation in the concentration of reactive species. Thus, a spatial distribution \tilde{T}_{x,y}^{c} of the set-point temperature \tilde{T}^{c} is obtained that thus allows a distribution of the effective temperature of the cell to be obtained the uniformity of which is improved.

Moreover, optionally and possibly complementarily with the step of specifying the set-point temperature described above, it is advantageous to specify the spatial distribution T_{x,y}^{c} of the set-point temperature T^{c} as a function of the spatial distribution φ_{x,y} of the relative humidity φ in the distributing circuits. The relative humidity φ is defined conventionally as the ratio of the partial pressure P_{H2O} of the water vapor contained locally in the gas flowing through the distributing circuit to the saturated vapor pressure Pₛₐₜ. The relative humidity φ has an effect on the rate of the electrochemical reactions. Thus, to compensate for the local variation in relative humidity, it is advantageous to define a set-point temperature that compensates for this local variation, for example for local humidification or dehumidification in the distributing circuits, so that the effective temperature of the cell in operation has a uniform spatial distribution. To do this the spatial distribution \tilde{T}′_{x,y}^{c} of the specified set-point temperature \tilde{T}′^{c} may for example be written:

\tilde{T}′_{x,y}^{c}=T_{x,y}^{c}+K^{φ}·[φ_{x,y}/φᵢₙ] (5)

where φ_{x,y} is the spatial distribution of the relative humidity φ in the distributing circuit, φᵢₙ is the relative humidity at the inlet of the distributing circuit, and K^{φ} is a positive constant, for example close to 1, which may be subsequently adjusted. The distribution φ_{x,y} of the relative humidity φ may be estimated to the first order from the routing of the channels of the distributing circuit in question and by assuming a uniform current density throughout the active zone. It may also be more accurately determined by numerical or experimental measurement of the spatial distribution of the current density in a cell that is similar or identical to the reference cell, which allows the spatial distribution of the relative humidity to be deduced. Other relationships (5) may be used to specify the spatial distribution of the set-point temperature from the spatial variation in the relative humidity. Thus, a spatial distribution \tilde{T}_{x,y}^{c} of the set-point temperature \tilde{T}^{c} is obtained that thus allows a distribution of the effective temperature of the cell to be obtained the uniformity of which is improved.

In a step 230, a spatial distribution Q_{x,y}^{r} of a first thermal quantity representative of the effective local production of thermal energy Q^{r} by the cell in operation is obtained. The first thermal quantity is here the effective local heat flux produced by the cell in operation, or a quantity that is proportional thereto, such as the effective current density I^{r} produced by the cell (cf relationship 1). This distribution Q_{x,y}^{r} of the effective produced heat flux Q^{r} is not estimated but is issued from a measurement taken by experimental or numerical means. It may thus be obtained by experimental measurement of an electrochemical cell having the same properties as the reference cell defined in step 210, for example by means of a S++ board such as the aforementioned, which for example measures the spatial distribution of the current density I^{r}, or any other suitable technique. The distribution Q_{x,y}^{r} of the effective produced heat flux Q^{r} may alternatively be obtained by numerical simulation using an electrochemical cell model having the same functional and structural characteristics as those of the reference cell, for example the model described in the aforementioned publication by Fink & Fouquet 2011.

In a step 240, the spatial distribution D_{x,y}^{e} of a second thermal quantity D^{e} is estimated from said spatial distribution T_{x,y}^{c} of the set-point temperature T^{c} defined in step 220 and from said spatial distribution Q_{x,y}^{r} of the effective produced heat flux, which distribution is obtained in step 230. The second thermal quantity is representative of the local heat removal and here corresponds to the flow rate of the heat-transfer fluid through the cooling circuit allowing a calorific power P_{x,y} of removal of the effective produced heat flux Q^{r} to be obtained. The effective temperature of the cell is then substantially equal to the set-point temperature T^{c}.

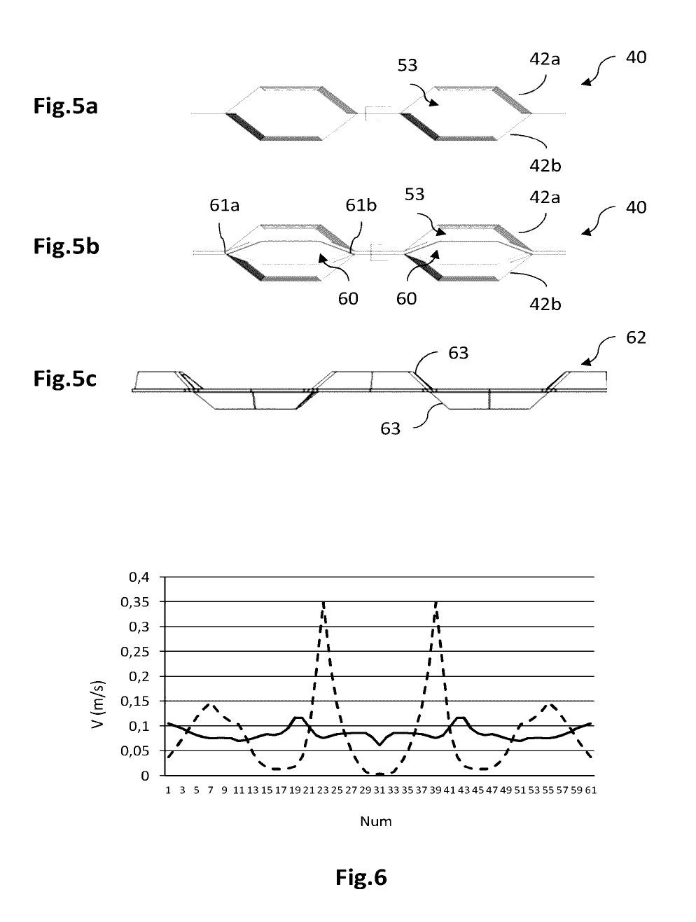

To do this, as illustrated in FIG. 5, a model of the cooling circuit is discretized into a two-dimensional or three-dimensional, here two-dimensional, mesh each mesh cell of which is an elementary volume (i,j) passed through by the heat-transfer fluid. Thus, each mesh cell (i,j) of the distributing circuit has two known quantities:

the local set-point temperature T_{i,j}^{c} (defined in step 220), and

the effective local produced heat flux Q_{i,j}^{r} (which flux is measured in 230), and one unknown quantity:

the local flow rate D_{i,j}^{e} of heat-transfer fluid (to be estimated in step 240).

Next, the amount of heat and fluid transferred between the mesh cell in question and the adjacent mesh cells is calculated by determining, on the one hand, the temperature differences and, on the other hand, the flow rates of the heat-transfer fluid at the four facets of the mesh cell in question. This calculation may be carried out by numerical simulation by computer, on said mesh. This amounts to solving a discrete numerical model relating the second thermal quantity, namely here the local flow rate of the heat-transfer fluid, to the local temperature and to the first thermal quantity, namely here the local heat flux. The numerical model, which is what is called an electrochemical model, may be expressed by relationship (8), which expresses local heat flux as a function of local temperature and the local flow rate of the heat-transfer fluid.

The temperature differences at the four facets of the mesh cell (i,j) may be calculated in the following way:

δT_{i,j}¹=T_{i,j}^{c}−T_{i,j+1}^{c} (6-1)

δT_{i,j}²=T_{i,j}^{c}−T_{i-1,j}^{c} (6-2)

δT_{i,j}³=T_{i,j}^{c}−T_{i+1,j}^{c} (6-3)

δT_{i,j}⁴=T_{i,j}^{c}−T_{i,j-1}^{c} (6-4)

The flow rates of the heat-transfer fluid at the four facets of the mesh cell (i,j) may be defined by projecting the flow rate D_{i,j}^{e} to be estimated (here a vectorial datum) onto the vectors eₓ and e_{y} passing through the mesh cells (i−1,j), (i,j) and (i+1,j), and through the mesh cells (i,j−1), (i,j) and (i,j+1), respectively:

d_{i,j}¹=(D_{i,j}^{e}·e_{y}+D_{i,j+1}^{e}·e_{y})/2 (7-1)

d_{i,j}²=(D_{i,j}^{e}·eₓ+D_{i-1,j}^{e}·eₓ)/2 (7-2)

d_{i,j}³=(D_{i,j}^{e}·eₓ+D_{i+1,j}^{e}·eₓ)/2 (7-3)

d_{i,j}⁴=(D_{i,j}^{e}·e_{y}+D_{i,j-1}^{e}·e_{y})/2 (7-4)

By convention, the local flow rate d_{i,j} at the facets of the mesh cell in question is considered to be positive when the fluid enters into the mesh cell (i,j) and negative when the fluid exits therefrom.

Lastly, the flow rate D_{i,j}^{e} of the heat-transfer fluid is estimated using the relationship:

Q_{x,y}^{r}≈Q_{i,j}^{r}=Σₖ₌₁⁴d_{i,j}^{k}·cₚ·δT_{i,j}^{k} (8)

Thus, the spatial distribution D_{i,j}^{e} of the flow rate D^{e} of the heat-transfer fluid through the cooling circuit of the bipolar plate, and therefore that of the calorific power P_{x,y} removed by the calorific fluid, required for the distribution T_{x,y}^{r} of effective temperature T^{r} to correspond to that T_{x,y}^{c} of the set-point temperature T^{c} is obtained, while taking into account the distribution Q_{i,j}^{r} of the effective local flux of heat Q^{r} produced within the cell.

In a step 250, the spatial distribution Rh_{x,y}^{f} of the hydraulic resistance Rh of the cooling circuit is determined from the spatial distribution D_{x,y}^{e} of flow rate D^{e} Of calorific fluid estimated in step 240. It may be obtained by parametric study of the cooling circuit of the bipolar plate, for example by means of a particle image velocimetry (PIV) technique or any other suitable technique. The distribution D_{x,y}^{e} of the mass flow rate D^{e} may also be obtained by iterative inverse numerical simulation using a flow simulation software package such as FLUENT or COMSOL for example. Concretely, the local value of the hydraulic resistance within the cooling circuit is modified and the corresponding local flow rate measured. This operation is reiterated until the measured local flow rate is substantially equal to the estimated distribution D_{x,y}^{e}.

Advantageously, the distribution is determined without modifying the flow properties in the circuits for distributing reactive species. To do this, the hydraulic diameter of the cooling ducts is not increased, but the hydraulic resistance (or the local geometric coefficient) within the cooling circuit is modified, in the parametric study or the study by numerical simulation.

Thus the spatial distribution Rh_{x,y}^{f} of the hydraulic resistance Rh of the cooling circuit of a bipolar plate has been determined so that the distribution of the corresponding flow rate of heat-transfer fluid D^{e} results in a local calorific power P_{x,y} removed by the heat-transfer fluid allowing the effective temperature T^{r} of the cell to be made substantially equal to the set-point temperature T^{c}, while taking into account the distribution of the effective flux of heat Q^{r} produced within the cell. Insofar as the set-point temperature is advantageously spatially uniform, the cell in operation has an effective temperature the distribution of which is also substantially uniform, thus allowing the lifetime of the cell to be preserved.

A method for producing a bipolar plate of the electrochemical cell will now be described. An electrochemical cell that is identical or similar to the reference cell defined in steps 110 and 210 is considered. It thus includes two electrodes separated from each other by an electrolyte and placed between two bipolar plates. Each bipolar plate includes distributing circuit suitable for bringing reactive species to the electrodes and a cooling circuit through which a heat-transfer fluid may flow in order to remove the heat produced by the cell in operation. The cooling circuit has a hydraulic resistance Rh that is spatially distributed with an initial distribution Rh_{x,y}ⁱ. Using the method described above with reference to FIG. 2 or 3, a spatial distribution Rh_{x,y}^{f} of the hydraulic resistance Rh of the cooling circuit of the bipolar plate is determined. Next, in a step 160 (FIG. 2) or 260 (FIG. 3), the bipolar plate is produced in such a way that the hydraulic resistance Rh has the determined spatial distribution Rh_{x,y}^{f}.

As illustrated in FIGS. 5a to 5c, the bipolar plates 40 of the electrochemical cell may be formed from two portions 42a, 42b, for example two sheets containing embossments obtained by pressing or molding, said sheets being joined to each other. Thus, FIG. 5a illustrates a partial cross-sectional view of a bipolar plate 40 in which the cooling ducts 53 are formed by embossments, and have a local hydraulic diameter dh_{x,y} that defines a local hydraulic resistance Rh_{x,y}.

FIG. 5b illustrates a similar view to that in FIG. 5a, but in which at least some of the ducts 53 of the bipolar plate 40 are equipped with one or more inserts 60 allowing hydraulic diameter and therefore hydraulic resistance to be decreased locally. The inserts 60 are here components that have a thickness, in a plane transverse to the longitudinal axis of the ducts, suitable for decreasing the flow zone of the heat-transfer fluid. They have two longitudinal edges 61a, 61b via which they are fastened at the junction of the sheets 42a, 42b of the bipolar plate 40. This type of insert 60 may be inserted into a zone Zⱼ determined as described above with reference to the method according to the first embodiment, or into a duct kⱼ determined as described above with reference to the method according to the second embodiment.

FIG. 5c illustrates a cross-sectional view along a longitudinal axis of an insert 62 according to one variant. This insert 62 here allows the local geometric coefficient ζ_{x,y} and therefore the flow rate in the duct in question to be modified. The insert 62 is here a structured plate section, for example a sheet of substantially constant thickness containing at least one embossment 63 that protrudes with respect to a plane parallel to the plane of the bipolar plate. The insert 62 is placed in at least in at least one portion of the cooling ducts 53 so that the embossments 63 are oriented in the longitudinal direction of the ducts. The insert 62 does not modify the hydraulic diameter of the ducts 63 that are equipped therewith but create minor head losses, thereby decreasing the flow rate of the heat-transfer fluid. Each insert 62 may include one or more embossments 63 distributed, optionally periodically, with the spatial distribution of the minor head losses to be generated in the cooling duct, the embossments possibly being identical to one another. As for the insert 60, it has lateral edges 61a, 61b via which it is fastened to the bipolar plate 40, at the junction between the two sheets 62a, 42b. As above, the insert 62 may be inserted into a zone Zⱼ determined as described above with reference to the method according to the first embodiment, or in a duct kⱼ determined as described above with reference to the method according to the second embodiment.

The inserts 60, 62 may be separate from each other or form zones of one and the same sheet extending between the two sheets 42a, 42b of the bipolar plate 40. Thus, because of the presence of the inserts, the cooling circuit has a hydraulic resistance Rh (or a geometric coefficient ζ) distributed with the spatial distribution Rh_{x,y}^{f} determined by the method according to the invention.

FIG. 6 illustrates an example of measurements of the flow rate through ducts of the cooling circuit of a bipolar plate (expressed here by the average speed of the fluid in each duct). The dashed curve corresponds to the flow rate in the cooling ducts of a reference bipolar plate for which the hydraulic resistance Rh is spatially distributed with an initial distribution Rh_{x,y}ⁱ. It will be noted that the flow rate in the ducts is not uniform insofar as certain ducts present a substantially zero speed whereas other ducts exhibit a speed peak of about 0.35 m/s. These nonuniformities in the flow rate of the heat-transfer fluid result in nonuniformities in the removed calorific power P_{x,y}, this being liable to cause large nonuniformities in the effective temperature within the cell. The solid curve corresponds to the flow rate in the ducts of the same bipolar plate, but in which the hydraulic resistance Rh is spatially distributed with the distribution Rh_{x,y}^{f} determined by the method according to the invention. To achieve this, inserts 60 and/or 62 were introduced into the cooling ducts in the zones Zⱼ and/or the ducts kⱼ, as described above. The large nonuniformities in flow rate have been decreased or even removed, so that the flow rate in the cooling circuit is substantially uniform from one cooling duct to the next. This results in a substantially uniform removed calorific power P_{x,y}, thereby allowing nonuniformities in the temperature of the cell in operation to be limited or even avoided.

Particular embodiments have just been described. Alternative variants and various modifications will be apparent to the person skilled in the art.

1. Method for determining a spatial distribution (Rh_{x,y}^{f}) of a parameter of interest (Rh) representative of heat removal within a bipolar plate of an electrochemical cell, said cell including two electrodes separated from each other by an electrolyte and placed between bipolar plates suitable for bringing reactive species to the electrodes and for removing the heat produced by the cell in operation, the bipolar plates being formed from two sheets that are bonded to each other, each sheet including embossments forming, in what is called an external face, a circuit for distributing a reactive species, the embossments of the sheets together forming, in what are called internal faces that are opposite the external faces, a cooling circuit including cooling channels that communicate fluidically with one another between an inlet and an outlet of the cooling circuit, comprising:
i) providing an electrochemical cell, within which the parameter of interest (Rh) is distributed with an initial spatial distribution (Rh_{x,y}^{f}) and for which the spatial distribution of a temperature within the electrochemical cell in operation has at least one local value higher than or equal to a preset maximum local value;
ii) defining a spatial distribution (T_{x,y}^{c}) of a set-point temperature (T^{c}) within the cell in operation, said distribution being such that the local temperature values are lower than preset maximum local values;
iii) measuring a spatial distribution (Q_{x,y}^{r}) of a first thermal quantity (Q^{r}) representative of a local production of thermal energy within said electrochemical cell in operation;
iv) estimating a spatial distribution (D_{x,y}^{e}) of a second thermal quantity (D^{e}) representative of a local flow rate of a heat-transfer fluid in a cooling circuit of a bipolar plate of the electrochemical cell in operation, depending on said spatial distribution (T_{x,y}^{c}) of the set-point temperature (T^{c}) and on said spatial distribution (Q_{x,y}^{r}) of the first thermal quantity (Q^{r}), so that the spatial distribution of the temperature of said electrochemical cell in operation, the first thermal quantity (Q^{r}) of which cell having said measured spatial distribution (Q_{x,y}^{r}) and the second thermal quantity (D^{e}) of which cell having said estimated spatial distribution (D_{x,y}^{e}), is substantially equal to that (T_{x,y}^{c}) of the set-point temperature (T^{c}); and
v) determining a spatial distribution (Rh_{x,y}^{f}) of the parameter of interest (Rh) depending on the estimated spatial distribution (D_{x,y}^{e}) of the second thermal quantity (D^{c}).

2. Determining method according to claim 1, wherein the parameter of interest is a hydraulic resistance (Rh) or a geometric coefficient (ζ) of minor head losses within a cooling circuit of at least one of the bipolar plates, through which circuit a heat-transfer fluid is intended to flow.

3. Determining method according to claim 1, wherein determining the spatial distribution of the parameter of interest is furthermore carried out depending on a preset overall electrical power value of the electrochemical cell.

4. Determining method according to claim 1, wherein estimating a spatial distribution of the second thermal quantity includes:
generating a mesh of a cooling circuit of at least one bipolar plate of the electrochemical cell, through which circuit a heat-transfer fluid is intended to flow; and
simulating numerically by computer the second thermal quantity on said mesh, by solving a discrete numerical model relating the second thermal quantity to the local temperature and to the first thermal quantity.

5. Determining method according to claim 1, wherein the first thermal quantity is representative of a production of thermal energy (Q^{r}) within the cell in operation, and the second thermal quantity is representative of a flow rate (D^{c}) of a heat-transfer fluid through a cooling circuit of a bipolar plate of the cell.

6. Determining method according to claim 5, wherein, in iv), the spatial distribution (D_{x,y}^{e}) of the flow rate (D^{e}) of the heat-transfer fluid allowing said produced heat (Q^{r}) to be removed is estimated depending on the spatial distribution (Q_{x,y}^{r}) so as to obtain said spatial distribution (T_{x,y}^{c}) of the set-point temperature (T^{c}).

7. Determining method according to claim 6, wherein, in v), the spatial distribution (Rh_{x,y}^{f}) of the parameter of interest (Rh) is determined so that the flow rate of the heat-transfer fluid through the cooling circuit has the spatial distribution (D_{x,y}^{e}) estimated beforehand.

8. Method for producing an electrochemical-cell bipolar plate, comprising:
considering a reference electrochemical cell, said cell including two electrodes separated from each other by an electrolyte and placed between bipolar plates suitable for bringing reactive species to the electrodes and for removing the heat produced by the cell in operation via a cooling circuit through which a heat-transfer fluid is intended to flow, the cooling circuit having a parameter of interest (Rh) representative of a hydraulic resistance (Rh) or a geometric coefficient (ζ) of minor head losses, said parameter being spatially distributed with an initial distribution (Rh_{x,y}ⁱ);
determining a spatial distribution (Rh_{x,y}^{f}) of the parameter of interest (Rh), using the method (100; 200) according to claim 1; and
producing said bipolar plate in such a way that the parameter of interest (Rh) has the determined spatial distribution (Rh_{x,y}^{f}).

9. Method for producing a bipolar plate according to claim 8, wherein an insert is added to at least one duct of the cooling circuit, said insert having a thickness transverse to a longitudinal axis of said duct suitable for locally increasing the hydraulic resistance of the duct.

10. Method for producing a bipolar plate according to claim 8, wherein an insert is added to at least one duct of the cooling circuit, said insert being formed from at least one plate section of substantially constant thickness, including at least one embossment suitable for locally creating a minor head loss.

11. Method for producing an electrochemical cell including two electrodes separated from each other by an electrolyte and placed between two bipolar plates suitable for bringing reactive species to the electrodes and for removing the heat produced by the cell in operation, comprising:
considering a reference electrochemical cell having a parameter of interest (Rh) representative of the electrical power production of the cell and distributed with an initial spatial distribution (Rh_{x,y}ⁱ);
determining a spatial distribution (Rh_{x,y}^{f}) of the parameter of interest (Rh) using the determining method according to claim 1; and
producing the electrochemical cell, on the basis of the reference electrochemical cell in which the parameter of interest (Rh) has the determined spatial distribution (Rh_{x,y}^{f}).

12. Data storage medium containing instructions for implementing the determining method according to claim 1, these instructions being executable by a processor.

13. Method for producing a bipolar plate according to claim 9, wherein an insert is added to at least one duct of the cooling circuit, said insert being formed from at least one plate section of substantially constant thickness, including at least one embossment suitable for locally creating a minor head loss.
